(19) United States
(12) Patent Application Publication
(10) Pub. No.: US 2023/0270097 A1
(43) Pub. Date: Aug. 31, 2023

(54) SYSTEM FOR IMAGE BASED REMOTE SURVEILLANCE IN AN INSECT TRAP

(71) Applicant: VecTech LLC, Baltimore, MD (US)

(72) Inventors: Jewell Brey, Baltimore, MD (US); Adam Goodwin, Baltimore, MD (US); Tristan Ford, Baltimore, MD (US); Sanket Padmanabhan, San Diego, CA (US); Bala Sudhakar, Hyattsville, MD (US); George Constantine, Baltimore, MD (US); Margaret Glancey, Horsham, PA (US)

(73) Assignee: VecTech LLC, Baltimore, MD (US)

(21) Appl. No.: 18/082,431

(22) Filed: Dec. 15, 2022

Related U.S. Application Data
(60) Provisional application No. 63/289,758, filed on Dec. 15, 2021.

(51) Int. Cl. A01M 1/02; G03B 15/05; A01M 1/08; A01M 1/10; H04N 23/661; H04N 7/18

(52) U.S. Cl. CPC A01M 1/026; G03B 15/05; A01M 1/08; A01M 1/106; H04N 23/661; H04N 7/183; G03B 2215/0539; G03B 2215/0567

(57) ABSTRACT

The proposed apparatus, which functions to capture insects for research purposes, incorporates a mesh platform used to gather insects, at least one funnel used to direct insects to the mesh platform, a fan positioned at the base of the apparatus to create a down draft in the air flow which forces insects to gather on the mesh platform. A camera placed above the mesh platform and funnel to collect images of the insects on the mesh platform.

The applicant claims the benefit of U.S. Provisional Application 63/289,758 filed on Dec. 15, 2021, which is incorporated in its entirety herein.

### FIELD OF INVENTION

The invention relates to insect traps, image capture and data collection.

### BACKGROUND

Most mosquito traps consist of an attractant to lure mosquitoes close to the trap, and a fan to pull them into the trap, where they remain confined in a catch bag due to the fan's airflow until a user removes the catch bag. To monitor mosquito populations for public health and environmental health purposes, mosquito control organizations (MCOs) set mosquito traps throughout a region, leave them for roughly a day at a time, and then retrieve the trap catches the next day. They then bring the specimens back to the lab, where they are identified under a microscope. The primary problem with this method is the high labor cost required to collect a high density of data points in a region; this burden often results in under-sampling, resulting in mosquito control actions that are either unwarranted or a lack of mosquito control actions when they are warranted. Both under or over-acting tendencies of mosquito control organizations pose a public health and/or environmental health risk.

Over the past 5-10 years, the terms connected devices, internet of things (IoT), and smart devices have all become commonplace. The concept of IoT mosquito traps is highly attractive for mosquito surveillance because it implies a dramatic reduction in the labor cost required to get mosquito surveillance data. Essentially, rather than traveling to each mosquito trap for each data point and manually counting and identifying specimens in the lab, the traps automatically calculate and identify the mosquitoes as they enter the trap and send the data remotely. This way, the traps only need to be visited when they need to be maintained, and information is provided routinely.

Other groups have attempted to do this using different methods. Most notably, optic-acoustic sensors have been used in electronically active traps to analyze the wingbeat frequency of specimens entering the trap using deep learning to classify the specimen's species. The accuracy of this method is very high using lab specimens, which tend to be raised in a homogenous environment (Geier 2016). Unfortunately, the accuracy suffers dramatically when used to identify wild-caught specimens from various locations and environments due to the wide variance of mosquitoes in the wild and non-target specimens (Day 2020). Another unique method uses an electronically passive mosquito trap, relying on sticky paper as the capture method (Goodwin 2020). The sticky paper is periodically imaged, and the images are analyzed using deep-learning computer vision algorithms. However, this method faces some implementation barriers, such as the low adoption rate of electronically passive mosquito traps and their relatively low specimen capture rate compared to electronically active mosquito traps.

Imaging has previously been dismissed as a viable data acquisition method for an active fan-based trap because the catch bags are amorphous, and imaging at close distances requires a flat field of view or object plane. Additionally, the number of specimens captured in an active trap is often very high, sometimes 100s to 1000s specimens in a single night. Thus, keeping the mosquitoes in a flat plane and not overlapping for quality imaging was also considered a significant barrier.

Similar barriers exist for fan-based traps for other insects as well. As such, modifications in attractants, visual cues, and trap geometry unrelated to the invention described herein may also make the design applicable to other insects.

### DESCRIPTION OF THE FIGURES

FIG. 1 is a cross-sectional side view of an embodiment of the invention as implemented in a mosquito trap.

FIG. 3 is a cross-sectional side view of an alternative embodiment of the invention.

FIG. 4 is a cross-sectional side view of an embodiment of the invention.

FIG. 5 shows the components of a spherical mesh platform holder design, according to an embodiment.

FIG. 6 shows a cross-sectional view of the spherical mesh platform holder embodiment.

FIG. 7 is a cross-sectional side view of an embodiment of the invention with dimensions for components.

FIG. 8 is a cross-sectional side view of an embodiment of the invention

FIG. 9 is a top view from the camera of an embodiment of the invention.

Further embodiments, features, and advantages of the present invention, as well as the operation of the various embodiments of the present invention, are described below with reference to the accompanying drawings.

### DETAILED DESCRIPTION OF THE INVENTION

The present invention relates to an imaging attachment to an electronically-active fan-based mosquito or flying insect trap. The apparatus may be connected to a data network and, in an embodiment, represents an internet-of-things (IoT) mosquito or flying insect trap. The invention comprises a mesh platform placed in the intake path of the fan inside an insect trap capture funnel and the camera centered above the mesh platform. Literature shows that an airflow of 1.83 to 2.85 m/s is needed to effectively pull mosquitos into a trap (Wilton, 1972). The addition of the secondary funnel shall not reduce airflow below this threshold; the user may adjust the fan's power as necessary to meet this standard.

The mesh platform serves as the imaging platform and represents the camera's field of view and object plane. Periodically, the camera will capture a high-resolution image of the mesh platform. The optics and hardware may be ruggedized to withstand external forces such as falling, water and debris exposure, fauna disruption, and fluctuations in temperature and humidity. The image may be analyzed directly on a microprocessor locally or after transmission to a cloud-based server which would then analyze the image to determine if it is a target insect.

Specimens will then be transferred into a secondary catch location. In a preferred embodiment, this is achieved by rotating the mesh platform 180 degrees along an axis coplanar to the plane of the mesh platform, thereby transferring the specimens into a catch bag secured below the mesh platform. In a particular embodiment, the mesh platform holder component is spherical with a hollowed core in the shape of an hourglass, with the mesh platform forming a circular cross-section of the smallest diameter of the core; the spherical geometry ensures that the secondary catch location (the spherical platform holder) is separated from the external environment, preventing trapped specimens from escaping during the rotation of the mesh platform. In another particular embodiment, specimens are only transferred to a secondary catch location if they are determined to be target insects. In this embodiment, if a non-target insect is detected, the specimen may be removed from the trap through the reversal of the fan to push the specimen back out to the environment. The frequency of the periodic imaging and then the transfer of insects into a secondary location, such as the catch bag, may be user-controlled depending on the environment, use case, and expected frequency of specimens entering the trap. The routine removal of specimens from the imaging plane by this method:
1) limits the number of specimens that may be on the plane at a given time, decreasing the likelihood of specimen overlap or obstruction in the image;
2) eliminates a need to track which specimens have been imaged already versus those which are new; and
3) reduces the burden of tracking the time of the entry of each specimen.

Other components of the invention may include a secondary funnel to narrow the field of view, a lighting ring to illuminate the mesh platform, and a sensor for detecting the position of the mesh platform. To reduce airflow obstruction, the camera will be placed looking down on the mesh platform, raised above the trap entrance. IoT electronics will transmit images and/or identifications.

In a primary embodiment, the fan will be positioned after the mesh platform to prevent specimens from passing through the fan and sustaining damage before imaging and to keep the fan out of the path of the image. In a preferred embodiment, the fan will be after the secondary catch location, or catch bag, for the passage of airflow to minimize damage to the specimens if additional inspection of specimens is required. In a particular embodiment, the fan speed is modulated by rotating or flipping the mesh platform to maintain a consistent airflow speed at the entrance to the trap at the primary funnel. An airflow sensor placed within the primary funnel may be used as a feedback mechanism to dictate fan speed.

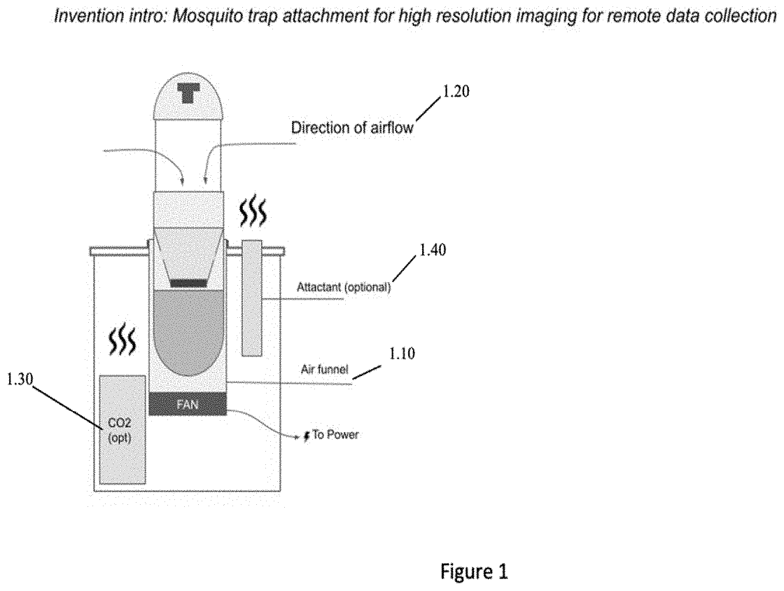

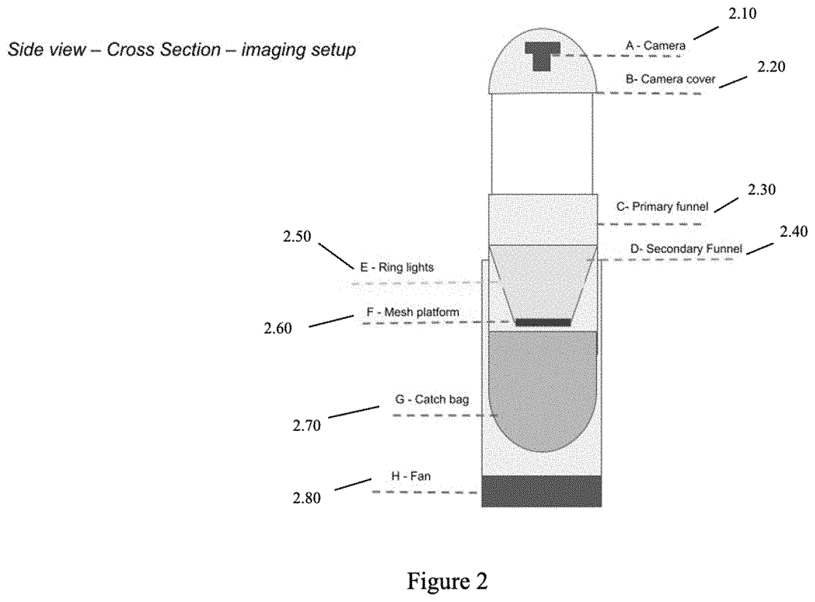

As shown in the embodiment of FIG. 1, the insects are pulled by the airflow into the catch funnel. Downward airflow (1.20) at an entrance of the apparatus through the air funnel (1.10) is created by the operation of a fan (2.80). This draws insects, such as mosquitoes, into the apparatus for imaging. The insects are held against the mesh platform by the airflow, where they are imaged by the camera. To facilitate the attraction of insects, a chemical attractant may be used such as pheromones, host-seeking attractants such as a CO2 source or scent-based attractant (1.30), lights of varying color or frequencies, or another attractant (1.40). In an embodiment, this apparatus or elements thereof may be integrated into an insect trap.

As shown in the embodiment of FIG. 2, the air funnel comprises a primary funnel 2.30 and a tapered secondary funnel 2.40. The embodiment of FIG. 2 includes the camera (2.10), the camera cover (2.20), the primary funnel (2.30), the secondary funnel (2.40), ring lights (2.50), the mesh platform (2.60), the catch bag (2.70), and the fan (2.80). The camera cover (2.20), protects and secures the camera (2.10). Furthermore, the camera cover may serve to block light from the sun, in the scenario where the trap is placed on the ground, such that the optical axis of the camera is vertical, and where the sun is at a near vertical angle. In this embodiment, the cover may be made larger to block direct sunlight from hitting the mesh platform. The primary funnel (2.30) serves as the primary entrance for insects and is located a distance from the camera cover (2.20) so as not to obstruct insects from entering the trap. The mesh platform (2.60) is the target field of view (FOV) for the camera (2.10). The camera is high enough above the mesh platform (2.60) that the camera (2.10) may achieve a depth of focus of at least 3 millimeters, such that insects held against the element (2.60) can be imaged in sufficient detail. In a preferred embodiment, where the target insects are mosquitoes, sufficient detail is achieved at a resolution of 22 micrometers. The resolution of 22 micrometers is found through empirical means, by artificially degrading a high-resolution dataset of mosquito images, and attempting to train deep learning models to classify species using the images. The images are degraded at varying levels of resolution, such that a resolution may be selected relative to the asymptotic limit of accuracy as the resolution increases. A similar method may be used for finding the required resolution for other insects as well. The ring lights (2.50) are oriented to illuminate the target FOV of the mesh platform (2.60). A luminosity sensor may be present to sense light from the light-emitting diodes and facilitate a feedback loop for maintaining consistent lighting on the mesh platform. The secondary funnel (2.40) is tapered to reduce the size of the mesh platform (2.60) and, thus, the target FOV. This allows for a higher resolution for a given camera sensor size. The mesh platform (2.60) rotates periodically after the camera (2.10) takes an image. When the mesh platform (2.60) rotates 180 degrees, the insects are moved into the catch bag (2.70). For further testing and inspection, a user can remove the catch bag (2.70). The fan (2.80) pulls insects into the trap and against the mesh platform (2.60).

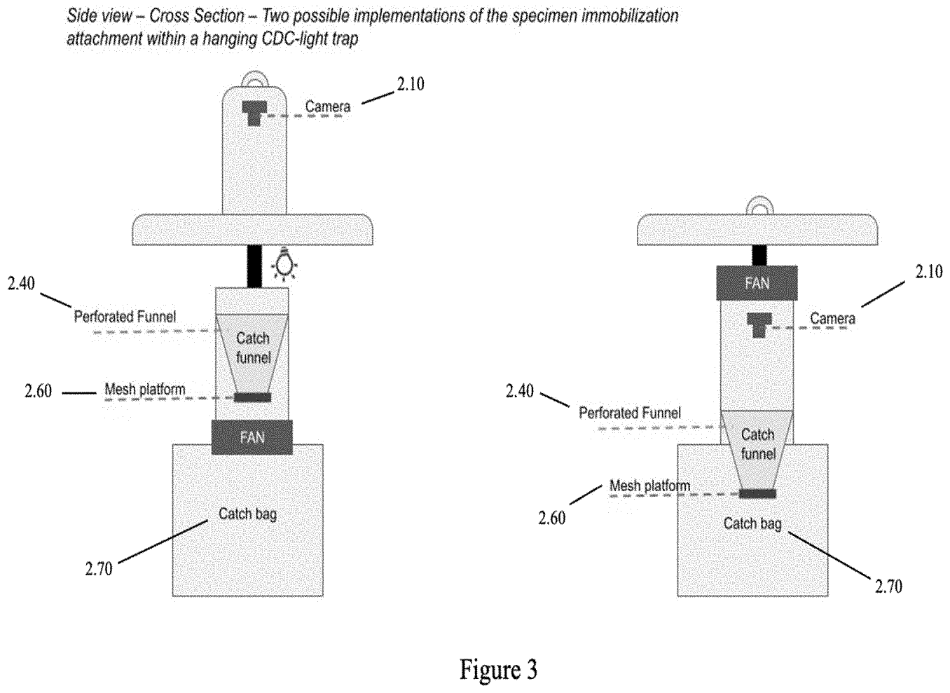

As shown in the embodiment of FIG. 3, the active trap's catch funnel (2.40) may comprise the primary funnel (2.30), to which a secondary funnel (2.40) and a mesh platform (2.60) are attached. In a preferred embodiment, the secondary funnel (2.40) will be of similar color to the primary funnel to minimize any change to the attractiveness of the trap to a target insect (2.30). The fan (2.80) draws specimens down through the primary funnel (2.30) and secondary funnel (2.40) and onto the mesh platform (2.60). The secondary funnel (2.40) is tapered, reducing the diameter of the mesh platform (2.60), and thus reducing the required field of view, enabling a higher resolution for a given sensor. In a particular embodiment, the secondary funnel (2.40) will be perforated or made of a mesh material, allowing airflow through the funnel wall. In a particular embodiment, the mesh will be comprised of a woven nylon material, with an open area of greater than 50 percent, that is stretched taut and held secured around a plastic or metal ring. In another embodiment, the mesh will be comprised of a perforated aluminum sheet or a woven steel mesh, embedded within a plastic ring. In a particular embodiment, the mesh platform is comprised of a black material of similar hue to the background behind the mesh platform of trap body as viewed by the camera. In particular, the color of the mesh platform color may be black and the background behind the mesh platform is the darkness inside an opaque insect trap. In a particular embodiment, the secondary funnel (2.40) will be perforated and have a lower percent open area as compared to the mesh platform (2.60) such that the net airflow through the mesh platform (2.60) is dominant to the net airflow through the secondary funnel (2.40). A camera [2.10] (shown in later figures) records an image of the specimens on the mesh platform periodically so they may be counted and identified using computer vision algorithms. Additionally, the mesh platform in FIG. 2 is configured to rotate one hundred eighty degrees along an axis intersecting the plane of the mesh periodically to release the specimens into the catch bag and clear the mesh platform. The airflow caused by the fan may facilitate movement of the specimens into the catch bag once the mesh platform is inverted. The catch bag may be a fabric material configured to be removed by the user at periodic intervals. An imaging sequence comprises the activation of the lights, the capture of an image of the specimens on the mesh platform with the camera, the turning off of the lights, and the inversion of the mesh platform. The platform may be subsequently rotated to return to its original position.

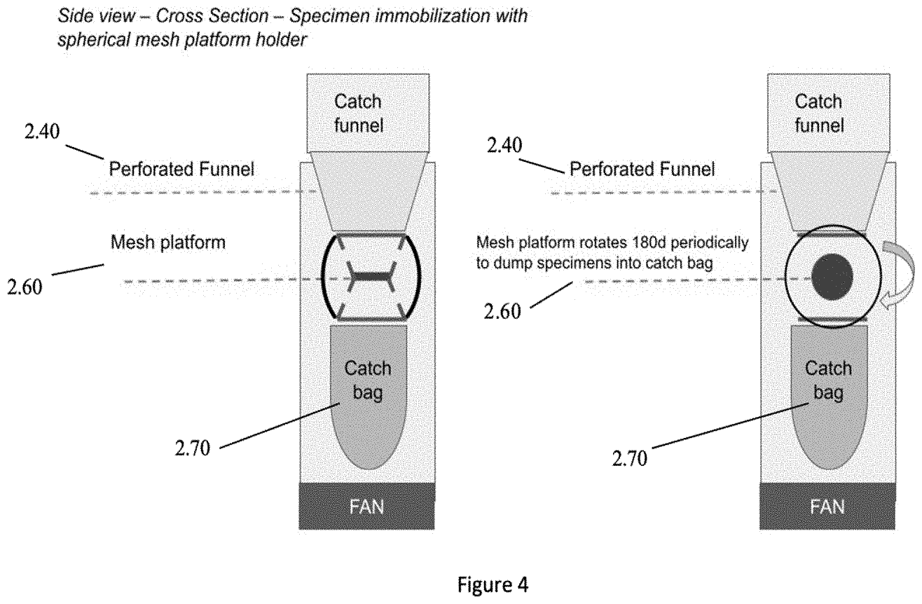

The embodiment in FIG. 4 shows a cross-section of the invention and displays the periodic rotation of the mesh platform (2.60), which separates the catch bag (2.70) from the external environment throughout the rotation of the mesh platform (2.60). This feature prevents any trapped specimens from escaping. Also depicted in FIG. 4 are the catch funnel (2.40) and the fan (2.80).

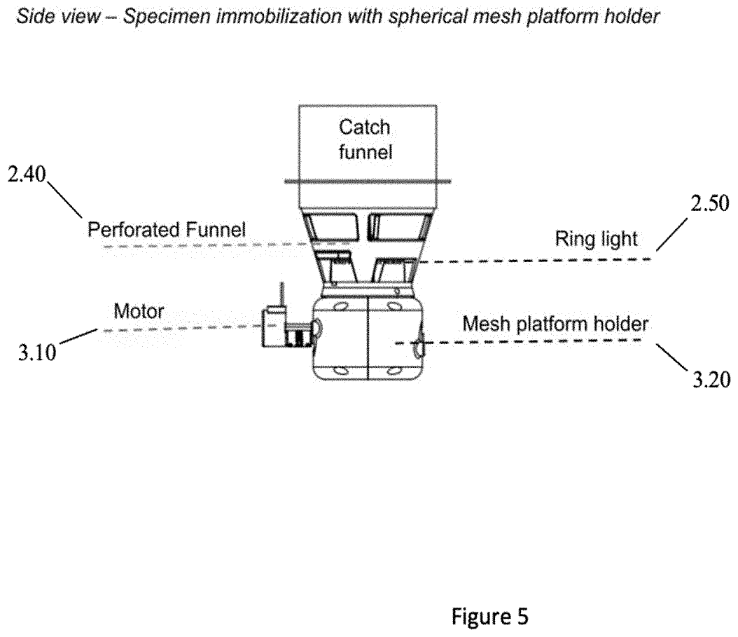

The embodiment of FIG. 5 shows a side view of the specimen immobilization with the mesh platform holder (3.20). The mesh platform holder (3.20) holds the mesh platform (2.60) in place. Also depicted in FIG. 5 is the motor (3.10), which rotates the mesh platform (2.60). In a primary embodiment, a motor is used to invert the mesh platform by rotating it about an axis coplanar with the mesh platform. This motor may be a stepper motor, with an encoder or rotational position sensor to track the position of the motor and thereby the position of the mesh platform. In another embodiment, a mechanical stop is used to stop the mesh platform once it reaches its position within the field of view. Between captures when the trap is in standby mode, the mesh platform may be held in place by magnets placed within the mesh platform and mesh platform holder.

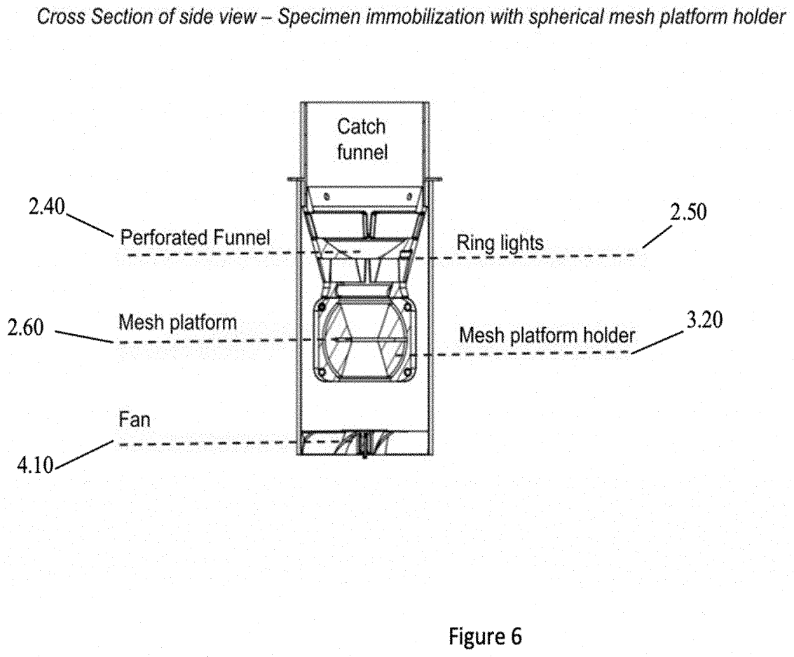

The embodiment of FIG. 6 includes a cross-section of the side view seen in FIG. 5. Also included are the fan (4.10) and the mesh platform (2.60).

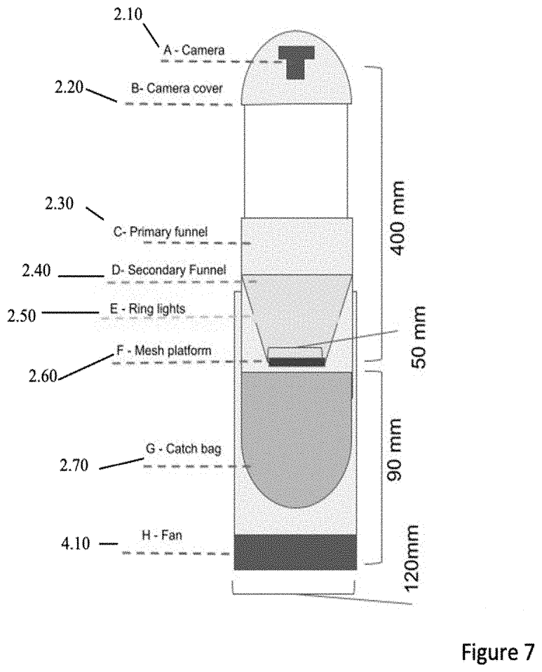

The embodiment of FIG. 7 includes proposed measurements for each feature. Specifically, the proposed distance between the camera (2.10) and the mesh platform (2.60) is 400 mm, the proposed width of the mesh platform (2.60) is 50 mm, the proposed distance between the top edge of the catch bag (2.70) and the base of the fan (4.10) is 90 mm, and the width of the entire apparatus is 120 mm. The camera position may be modulated along the plane orthogonal to the optical axis to accommodate tolerancing issues in manufacturing for aligning the field of view of the camera and the mesh platform. Generally, the camera and the mesh platform are configured and positioned to achieve at least a minimum resolvable feature size in a depth of focus optimized for a target insect, such that the insect can be properly identified with computer vision algorithms, or by a trained taxonomist reviewing the image. If the target insect is a mosquito, the minimum resolvable feature size is approximately 22 micrometers and the depth of focus is no less than 3 millimeters, corresponding to sizes of diagnostic features of mosquitoes and heights of the mosquitoes held against the mesh platform by the airflow. In an embodiment, the camera comprises a 35 millimeter effective focal length lens of aperture F/5.6, paired with a 7.857 millimeter diagonal (Type 1/2.3) 12.3 megapixel camera sensor, the lens is positioned 400 millimeters from the mesh platform, and the mesh platform is smaller than 50 millimeters in diameter.

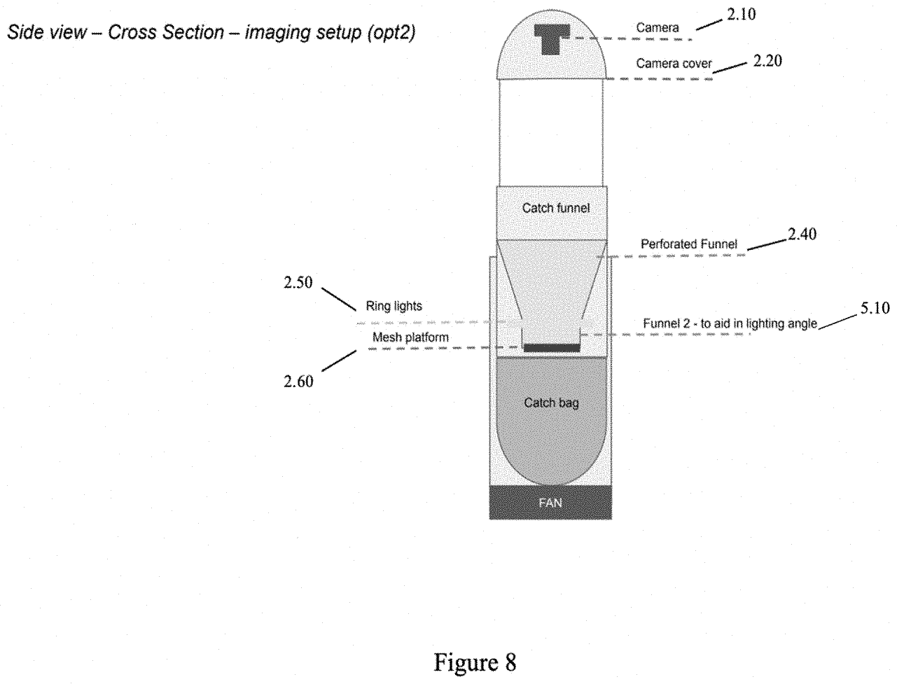

The embodiment in FIG. 8 includes a possible alternative imaging setup. In this embodiment, a third funnel (5.10) extends downward from the secondary funnel (2.40), hereafter referred to as funnel extension (5.10). The mesh platform (2.60) is attached to the funnel extension (5.10). In this embodiment, the ring lights (2.50) are set into the underside of the bottom of the second funnel (2.40), directly above the funnel extension (5.10). Additionally, in this setup, the extension funnel (5.10) may be matte white in color, such that when the ring lights (2.50) illuminate the walls of the extension, the scattered light may serve as a soft side lighting to minimize shadowing on the insects to be imaged on the mesh platform (2.60). In an alternative embodiment, the extension funnel may be matte black in color to minimize effects to the white balance algorithms embedded and used by the camera. In a particular embodiment, the extension funnel (5.10) may have an additional purpose as the mechanically rigid portion supporting the mesh platform (2.60) and to which torque is applied to achieve rotation. The mesh platform (2.60) obstruction to net airflow will thus be minimized, as the funnel extension (5.10), which rotates with the mesh platform (2.60), provides mechanical support to the mesh (see FIG. 5), eliminating the need for any elements supporting the mesh in the path of net airflow. In a particular embodiment, the extension funnel is synonymous with the mesh platform holder (3.20).

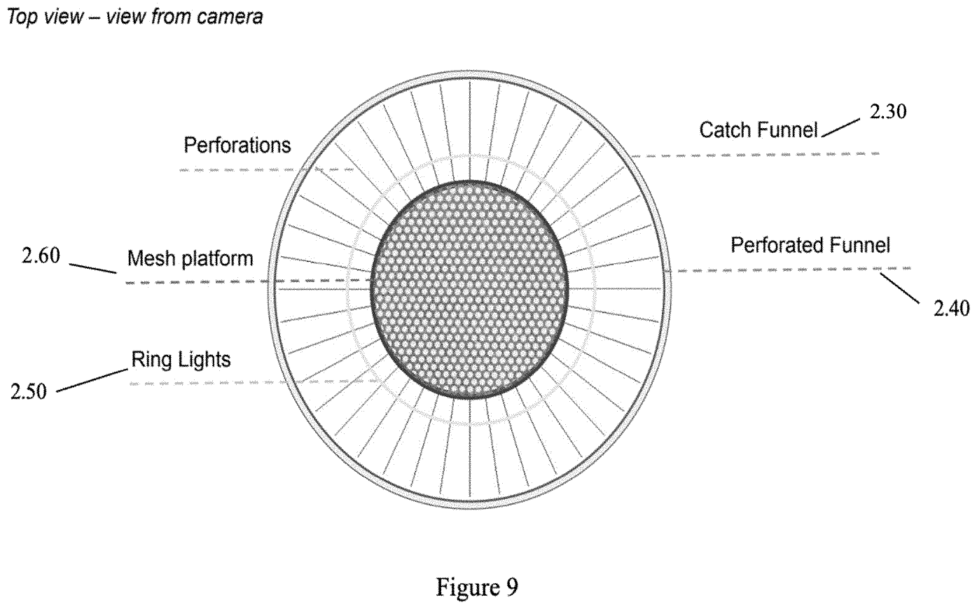

FIG. 9 discloses a top view of the invention according to one embodiment from the view of the camera (2.10). From this angle, it shows the mesh platform (2.60), the ring lights (2.50), the catch funnel (2.30), and the perforated funnel (2.40).

In an embodiment, the above-described apparatus may communicate with a computing device for processing images for identification and counting, located remotely or in the device via a wired or wireless connection. Such a connection may be implemented using a data network and may include the internet. Any known communication protocol may be used. Images of the mesh platform and specimens may be transmitted to the remote computing device periodically or aperiodically to allow counting and identifying the specimens at the remote computing device. In particular, the camera may comprise an interface to a network. A microprocessor may control the camera, lights, and mesh platform periodic inversion as well as one or more of a global system for mobile communication (GSM) module for interfacing with a digital mobile network and a wireless fidelity (WiFi) module for interfacing with a WiFi network, where the network is connected to a backend server for collecting data gathered by the apparatus for viewing by a user. Alternatively, in a particular embodiment, the counting and identification of specimens may be made on a computing device located within the trap attachment. In this case, the identifications and counts of groupings of insects are sent to remote servers with or without the associated images. The imaging sequence may be activated on a periodic schedule which may be controlled via communication with the backend server and managed by the microprocessor. An image from the camera may be processed by computer vision algorithms for counting and identification of the insects or attributes of the insects on the mesh platform.

In a preferred embodiment, the camera, which consists of a combination of a lens and camera sensor, should be held high enough above the mesh platform to meet two criteria: not obstructing airflow into the primary funnel, the entrance of the trap, and far enough away from the mesh platform to achieve a high depth of field on a single image. FIG. 7 shows components designed and dimensioned to achieve these criteria.

The foregoing description of the specific embodiments is intended to reveal the general nature of the invention so that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments.

### REFERENCES

Day C A, Richards S L, Reiskind M H, Doyle M S, Byrd B D. Context-dependent accuracy of the bg-counter remote mosquito surveillance device in north carolina. J Am Mosq Control Assoc. 2020; 36(2):74-80.
Goodwin A, Glancey M, Ford T, Scavo L, Brey J, Heier C, et al. Development of a low-cost imaging system for remote mosquito surveillance. Biomed Opt Express. 2020 May 1; 11(5):2560.
Geier M, Weber M, Rose A, Obermayr U, Abadam C, Kiser J, et al. The BG-Counter: A smart Internet of Things (IoT) device for monitoring mosquito trap counts in the field while drinking coffee at your desk. In: American Mosquito Control Association Conference. 2016. p. 341 1-2.
WILTON. D. P. and FAY, R. W. (1972), AIR FLOW DIRECTION AND VELOCITY IN LIGHT TRAP DESIGN. Entomologia Experimentalis et Applicata, 15: 377-386. https:doi.org/10.1111/j.1570-7458.1972.tb002222.x

What is claimed is:

1. An apparatus, comprising:
a mesh platform positioned orthogonal to a path of net airflow;
a funnel positioned prior to the mesh platform with respect to airflow;
a fan positioned parallel to the mesh platform, on an opposite side of the mesh platform relative to an entrance of the apparatus, and configured to draw air through the funnel and the mesh platform towards the fan; and
a camera facing the mesh platform and configured to image insects on the mesh platform;
a ring of light-emitting diodes facing the mesh platform to illuminate the platform for imaging.

2. The apparatus of claim 1, wherein the camera and the mesh platform are configured and positioned to achieve a minimum resolvable feature size in a depth of focus optimized for one or more target insects.

3. The apparatus of claim 2, wherein the camera position is modulatable along the plane orthogonal to the optical axis to accommodate tolerancing issues in manufacturing for aligning a field of view of the camera and the mesh platform.

4. The apparatus of claim 2, wherein the target insects comprise mosquitoes, and the minimum resolvable feature size is 22 micrometers and the depth of focus is no less than 3 millimeters, corresponding to sizes of diagnostic features of mosquitoes and heights of the mosquitoes held against the mesh platform by the airflow.

5. The apparatus of claim 4, wherein the camera comprises a 35 millimeter effective focal length lens of aperture F/5.6, paired with a 7.857 millimeter diagonal (Type 1/2.3) 12.3 megapixel camera sensor, the lens is positioned 400 millimeters from the mesh platform, and the mesh platform is smaller than 50 millimeters in diameter.

6. The apparatus of claim 1, further comprising a motor configured to invert the mesh platform to remove specimens from the mesh platform using the airflow from the fan.

7. The apparatus of claim 6, wherein an imaging sequence comprises the activation of the light emitting diodes, the capture of an image of the insects on the mesh platform with the camera, the turning off of the light emitting diodes, and the inversion of the mesh platform.

8. The apparatus of claim 6, further comprising a catch bag below the mesh platform and above the fan, such that inverting the mesh platform transfers the insects to the catch bag, where the catch bag is a mesh material and is configured to be removed by the user at periodic intervals.

9. The apparatus of claim 8, wherein the apparatus is integrated in an insect trap.

10. The apparatus of claim 6, wherein the funnel comprises:
a primary funnel configured to extend an imaging plane into the apparatus; and
a secondary funnel, conical in shape, with the mesh platform at the smaller end of the funnel, thus configured to reduce the size of the required field of view, allow a higher effective focal length, and thus enable higher resolution for the camera.

11. The apparatus of claim 10, wherein the primary funnel is equipped with an airflow sensor configured to detect the speed of airflow achieved by the fan.

12. The apparatus of claim 10, wherein the secondary funnel is perforated to increase an open area with respect to the airflow.

13. The apparatus of claim 10, wherein the ring of light-emitting diodes is embedded in the secondary funnel.

14. The apparatus of claim 10, where the mesh platform is secured within a spherical mesh holder with a hollowed core in the shape of an hourglass, wherein the mesh platform is located at the narrowest point within the hourglass.

15. The apparatus of claim 14, wherein the mesh holder is encased in a housing on all surfaces except for an inlet and outlet of the hollowed core, such that when the mesh holder inverts with the mesh platform, the insects are transferred off of the mesh platform due to the airflow and minimal airflow is permitted between the mesh holder and the mesh holder casing.

16. The apparatus of claim 6, wherein the camera comprises an interface to a network, the network comprising:
a microprocessor controlling the camera, lights, and mesh platform periodic inversion; and
one or more of a Global System for Mobile communication (GSM) module for interfacing with a digital mobile network and a wireless fidelity (WiFi) module for interfacing with a WiFi network,
wherein the network includes connectivity to a backend server for collecting data gathered by the apparatus for viewing by a user.

17. The apparatus of claim 16, wherein imaging is activated on a periodic schedule which may be controlled via communication with the backend server and managed by the microprocessor.

18. The apparatus of claim 16, wherein an image from the camera is processed by computer vision algorithms for counting and identification of the insects or attributes of the insects, on the mesh platform.

19. The apparatus of claim 6, where the motor is a stepper motor, with an encoder or rotational position sensor to track the position of the motor and thereby the position of the mesh platform.

20. The apparatus of claim 6, further comprising a mechanical stop configured to stop the rotation of the mesh platform once the mesh platform is coplanar with the camera field of view.

21. The apparatus of claim 6, where the mesh platform, once it is positioned within the field of view, is held in place by magnets placed within the mesh platform holder and its casing, keeping the mesh platform in position while the trap is in a standby mode.

22. The apparatus of claim 1, wherein the mesh platform is comprised of a material of similar hue to the background behind the mesh platform as viewed by the camera.

23. The apparatus of claim 22, where the mesh platform material is comprised of a woven steel wire of a percent open area greater than 50 percent.

24. The apparatus of claim 22, where the mesh platform material is comprised of an aluminum sheet of a percent open area greater than 50 percent.

25. The apparatus of claim 22, wherein the color of the mesh platform is black and the background behind the mesh platform is the darkness inside an opaque insect trap.

26. The apparatus of claim 22, where the mesh platform material is comprised of a woven nylon fabric of percent open area greater than 50 percent.

27. The apparatus of claim 1, further comprising a luminosity sensor configured to sense light from the light-emitting diodes and configured to operate in a feedback loop for maintaining consistent lighting on the mesh platform.

28. The apparatus of claim 1, further comprising a cover above the camera, the cover configured to protect the apparatus from rain and sun.
